(19) United States
(12) Patent Application Publication
(10) Pub. No.: US 2002/0135539 A1
(43) Pub. Date: Sep. 26, 2002

(54) Interaction with a volumetric display system

(76) Inventor: Barry George Blundell, La Marche (FR)

Correspondence Address: William T. Ellis, FOLEY & LARDNER, Washington Harbour, 3000 K Street, N.W., Suite 500, Washington, DC, 20007-5109, US

(21) Appl. No.: 09/789,526

(22) Filed: Feb. 22, 2001

(51) Int. Cl. G09G 5/00

(52) U.S. Cl. 345/6

(57) ABSTRACT

A display system including a volumetric display unit for displaying voxels in a three-dimensional image space; a graphics engine for feeding image data to the volumetric display unit; and a passive interaction device which uses a radiation sensor for sensing radiation from a selected region of the three-dimensional image space. The interaction device can be used to perform image operations within the image space, typically using a recognisable cursor which is grabbed, highlighted and moved within the image space.

### FIELD OF THE INVENTION

The present invention relates to an interaction tool for performing operations upon images depicted by a volumetric display system.

### BACKGROUND OF THE INVENTION

A volumetric display system is characterised by possessing a transparent physical volume within which visible light may be generated, absorbed or scattered from a set of localised and specified locations. Each of these locations corresponds to a voxel—this being the generalisation of the pixel encountered in conventional computer display systems. The voxel therefore forms the fundamental particle from which three dimensional (3-D) image components may be formed within the physical volume. This volume will be referred to as an image space and since image components may span its three physical dimensions a number of depth cues are automatically satisfied and so the three dimensionality of an image scene is naturally perceived. Volumetric systems permit images to be viewed directly and depending upon the manner in which the image space is formed may impose very little restriction upon viewing freedom. Consequently images may be viewed simultaneously by a number of observers: each observer having considerable freedom in viewing position.

Any terminology which is not defined within the present specification is drawn from a standard text delineating volumetric system theory and implementation [‘Volumetric three-dimensional display systems’, Barry Blundell and Adam Schwarz, Wiley-lnterscience, 2000, ISBN 0-471-23928-3 (Blundell et al)]. As described in Blundell et al, conventional volumetric displays consist of two main systems: a display unit and a graphics engine for controlling images displayed by the display unit.

The display unit is the physical device which, through the application of appropriate data (which may be passed in an electrical or non-electrical form) is able to give rise to visible image sequences and contains the image space within which they are cast. Three necessary and inter-dependent sub-systems may be identified and appropriately combined so as to form the display unit. These sub-systems are referred to as the image space creation sub-system, the voxel generation sub-system and the voxel activation sub-system. Referring to each of these in turn:

The image space creation sub-system is responsible for the production of an optically transparent physical volume within which image components may be positioned and possibly manipulated. Two broad approaches may be adopted in the implementation of this volume. In one case, the rapid and cyclic motion of a target surface (screen) may produce the image space. Display units of this type are referred to as swept volume systems. Examples are given in U.S. Pat. No. 3,140,415, U.S. Pat. No. 5,854,613, U.S. Pat. No. 5,703,606 and WO9631986. Alternatively, the image space may be defined by the extent of a static material or arrangement of materials. Display units of this type in which no reliance is placed upon mechanical motion for image space creation are referred to as static volume systems. Examples are given in U.S. Pat. No. 2,604,607 and U.S. Pat. No. 3,609,706.

The voxel generation sub-system denotes the underlying physical process by which optical changes are produced at locations within an image space and by means of which visible voxels are produced. Examples of processes which have been applied to the production of voxels include cathodoluminescence (for example Blundell B. G., Schwarz A J and Horrell D K, “The Cathode Ray Sphere: a Prototype Volumetric Display System”, Proceedings Eurodisplay '93 (Late News Papers), 593-6 (1993)) and the scattering of visible light (for example Soltan P, U.S. Pat. No. 5,854,613, “Laser Based 3D Volumetric Display System”, granted Dec. 29, 1998). In general, voxels can be characterised by two states—active and passive. When in the passive state the voxel is not visible and is only discernible when stimulated into an active (emissive) state. The time required to turn a voxel from its passive to active states is referred to as the voxel time (Tᵥ).

The voxel activation subsystem provides the stimulus to the voxel generation subsystems and is responsible for driving the passive to active transition of each voxel.

In the case of a volumetric system which employs the rotational motion of a target surface, the frequency of its rotation (f) must be equal to or in excess of the flicker fusion frequency (≈25 Hz). The inventor acknowledges that certain target surface configurations which symmetrically span the axis of rotation permit voxels to be updated twice per rotation. In this case f may be one half of the flicker fusion frequency. During a single rotation of the target surface, an image frame may be output and by appropriately sequencing frames, image animation may be supported. The total number of voxels which may be output during an image frame is referred to as the voxel activation capacity (Nₐ). Since the production of each voxel occupies a finite time (the voxel time referred to above) the voxel activation capacity may be expressed by

$${N}_{a} = \frac{P}{{T}_{v} f} \qquad ( 1 )$$

where P denotes the number of voxels which may be activated simultaneously (display unit parallelism). Increases in the voxel activation capacity (which are desirable in order to permit the production of images which show greater detail and ensure image predictability) may, in principle, be achieved by (a) reducing the frequency of rotation of the screen, (b) reducing the voxel time, (c) introducing display unit parallelism. Unfortunately, any reduction in the frequency of rotation of the screen below the flicker fusion frequency will result in unacceptable levels of image flicker. In the case of a display unit which uses one or more directed beam sources to stimulate voxel activation, a dot graphics technique is generally employed. In this case each beam source moves between locations at which voxels are to be activated. The voxel time may consequently be expressed by:

Tᵥ=Tₘ+Tₒₙ+T_{d}+T_{off} (2)

where Tₘ denotes the time required to move between available voxel sites, Tₒₙ the time required to turn the beam source on, T_{d} the duration for which the beam must dwell on a location in order to stimulate the voxel generation process and achieve a sufficient level of voxel brightness, and T_{off} the time required to turn off the beam source. Reduction in the voxel time will generally result in a reduction in the overall image intensity which is clearly undesirable and may make it impossible to clearly discern an image under ambient lighting conditions.

As a consequence, significant increases in the voxel activation capacity may only be achieved by increasing the parallelism supported by the voxel activation/voxel generation subsystems.

It would be desirable to provide a method of interacting with an image displayed in a volumetric display system.

One method which could be considered is a three-dimensional joystick. If we attribute a Cartesian XYZ co-ordinate system to the image space, then for example movement in the XY plane could be controlled by varying the angle of the joystick, and movement in the Z direction controlled by a separate button or by moving the joystick up and down. This method is highly non-intuitive and thus makes accurate and swift interaction virtually impossible.

One alternative method of interaction is described in FIG. 11 of U.S. Pat. No. 5,162,787. The unit has a display including at least one multi-frequency sensitive material which is illuminated with beams of energy from two spatial modulators. A hand held pointer provides the user with the ability to interact with the computer driving the display. The pointer has beam generators (for example IR devices). The output from the beam generators can be detected by sensors to determine the line along which the pointer is directed into the display.

This arrangement suffers from a number of problems. Firstly, the system must be calibrated accurately to enable the position of the pointer to be determined. Secondly, the system may suffer from refraction problems. More specifically. in the case of a swept volume system then the image space sub-system may include a transparent support structure (for example a glass cylinder) enclosing the image space which will refract light. In the case of a static volume system (see for example see Macfarlane, D. L., “A volumetric three dimensional display”, Applied Optics, 33(31) 7453-7457 (1994) and Macfarlane D. L., Schultz, G. R., Higley, P. D., and Meyer, J., “A voxel based spatial display”, SPIE Proceedings, 2177, 196-202 (1994)) the static material defining the image space will refract light. As a result, the apparent position of each voxel will be different to the actual position of each voxel in space (in the same way that the apparent position of a fish in a goldfish bowl is distorted). A user will direct the pointer at the apparent voxel position, resulting in a positioning error. The degree of distortion relates to the shape of the image space and the position of the observer. Therefore it is difficult or impossible to account for these refraction related errors. Thirdly, complex signal processing must be employed in order to accurately determine the position of the pointer. Fourthly, a large number of sensors are required, distributed around the image space. Fifthly, it is not possible to use more than one pointer, since the pointers will interfere with each other.

An object of the invention is to address these problems, or at least provide a useful alternative system.

### DISCLOSURE OF THE INVENTION

The invention provides a display system including a volumetric display unit for displaying images in a three-dimensional image space; a graphics engine for feeding image data to said volumetric display unit; and an interaction device having a radiation sensor for sensing radiation from a selected region of said three-dimensional image space and an output for feeding an output signal to said graphics engine, wherein said graphics engine is adapted to analyse said output signal in order to identify said selected region.

In contrast to U.S. Pat. No. 5,162,787 (which employs an active pointer which emits radiation), a passive device is employed to detect radiation emitted by the display unit. This means that an array of distributed sensors is not required as in U.S. Pat. No. 5,162,787. A further advantage (which is particularly useful in a volumetric system as compared to a conventional two-dimensional imaging system) is that one or more additional interaction devices can be provided. This enables, for example, one user to interact with the display from one side of the unit, and another user to interact (with their own separate interaction device) from the opposite side, without interference between the two devices. No calibration process is required, in contrast to U.S. Pat. No. 5,162,787. Instead, the system is ‘self-calibrating’ in the sense that the graphics engine can identify the position of the selected region on the basis of the output of the interaction device. The system does not suffer from the problems resulting from image refraction, because the radiation sensed by the interaction device will have passed through any refractive structures before arriving at the interaction device.

The display unit may be one of a variety of different designs as described in Blundell et al. For instance the display unit may be a swept-volume system (eg a rotating phosphor-coated helix addressed by a scanning electron beam) or a static volume system.

The display unit may be driven so that voxel activation is entirely sequential and only one voxel is in existence at any one time (that is, referring to equation (1) above, the display unit parallelism P=1). In this case, the graphics engine will receive a radiation pulse from the device when a voxel in the line of sight of the pointer is emitting radiation. The time of receipt of the pulse can then be compared with a voxel activation sequence being run by the graphics engine in order to uniquely determine which voxel has been selected. In this case the radiation sensor only requires a single radiation sensitive device.

However if the display unit is driven in parallel (ie P>1) then it is not possible to uniquely identify the voxel on the basis of time. This problem is illustrated in FIG. 6. An image space displays two voxels 51,52 which are aligned along a line of sight 53 of a pointer 54. In a serial system (P=1) these voxels will be displayed at a different time. In a parallel system (P>1) both voxels 51,52 may be displayed at the same time, so time of emission cannot be used to distinguish between them. A similar problem may also be present in a bi-level system (either P=1 or P>1) in which the voxels can remain active for some time until they are switched to their passive state by the voxel activation sub-system.

An alternative solution provided in a preferred embodiment of this invention is to display a cursor having an attribute which can be recognised by the graphics engine. The cursor may constitute a single voxel or a group (eg cluster) of voxels. This enables the cursor to be identified without using time-based detection, thus avoiding the problems discussed above. Once the cursor has been recognised by the graphics engine, then the graphics engine can highlight the cursor, and/or move or otherwise manipulate the cursor in response to user commands.

In a preferred example the graphics engine is adapted to monitor a position of a cursor image within a two-dimensional image field of said radiation sensor, and move said cursor image in response to a change in said position of said cursor image within said two-dimensional image field of said radiation sensor. The inventor recognises that this approach is more acceptable than the more standard re-draw approach employed in conjunction with an interaction device comprising a single optical sensor. In this case, as the interaction device is moved the cursor is repositioned in, for example, the north, south, east and west directions until it is once more detected by the interaction device. However, should this approach be employed, image flicker is likely to be perceived, cursor movement is unlikely to be smooth, and the maximum achievable rate of interaction device motion will be limited (as a consequence of the relatively low frame refresh frequencies characteristic of volumetric systems).

Cursor recognition can be achieved in a number of ways. For instance the cursor may have some unique shape or pattern which can be recognised by the graphics engine. However this presents the problem that the shape or pattern will change with viewing direction. Alternatively the cursor may be displayed in some unique colour, and the pointer equipped with a suitable filter. However in a preferred example the cursor is time encoded with a code sequence. At its simplest level the code sequence may constitute a series of regular pulses, and the cursor is recognised on the basis of the pulse frequency. Alternatively the code sequence may be more complex (for instance a pseudo-random binary sequence).

Typically a secondary input device (such as one or more buttons or sliders) is provided in order to move the cursor along the line of sight, or along some predetermined axis (eg X, Y or Z) or plane (eg XY, YZ or XZ). The input device may be part of the interaction device itself, or provided as part of a separate device. In one example the cursor may have a linear shape, and the length of the cursor can be varied using the input device.

The line of sight of the sensor can be determined by displaying a first marker (for example a cursor) at a first position along said line of sight in said three dimensional image space; displaying a second marker in said three dimensional image space; moving said second marker within said three dimensional image space; and analysing said output signal to sense when said second marker is at a second position along said line of sight.

At its simplest level the interaction device may only be used to highlight a selected region within the image space (eg by flashing or otherwise highlighting a voxel or voxel cluster). This may be useful for example in a medical imaging system. The device may also be used to move or otherwise manipulate images, for instance in a computer-aided-design system or games system. The output of the interaction device may also be used to issue external commands, for instance to a remotely-controlled robot, or to an aircraft or submarine. In this case, it is highly important that the interaction device is accurate since any errors in the external commands could have disastrous results.

### BRIEF DESCRIPTION OF THE DRAWINGS

The invention will now be described by way of example with reference to the accompanying drawings, in which:

FIG. 1 is a schematic view of an image space and two pointers;

FIG. 2 is a block diagram of a volumetric display system incorporating the image space and pointers of FIG. 1;

FIG. 3 is a detailed side view of a pointer;

FIG. 4 is a block diagram showing the main components of the pointer;

FIG. 5 is a view of a two-dimensional image field;

FIG. 6 is a view of an image space illustrating the problems associated with time-based measurements;

FIG. 7 is a view of an image space showing the construction of a line along a line of sight of a pointer;

FIG. 8 is a view of an image space showing a number of intersecting line cursors; and

FIG. 9 is a block diagram of an alternative serial graphics engine architecture.

### DETAILED DESCRIPTION OF THE PREFERRED EMBODIMENTS

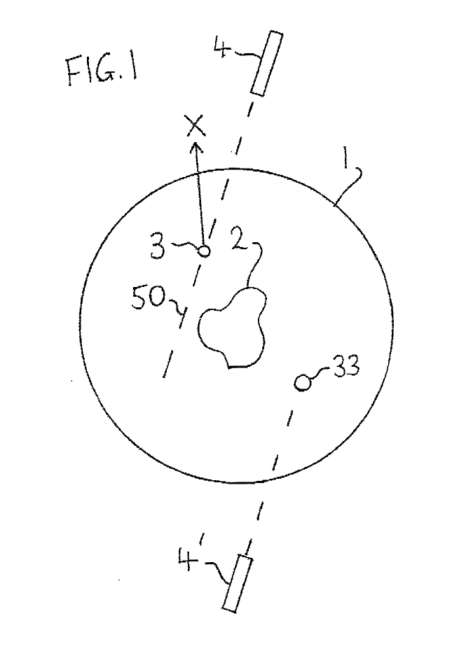

Referring to FIG. 1, a spherical or cylindrical image space 1 displays an object 2 and a spherical cursor 3. The cursor 3 can be grabbed and manipulated by means of a hand-held pointer 4 in order to interact with the object 2.

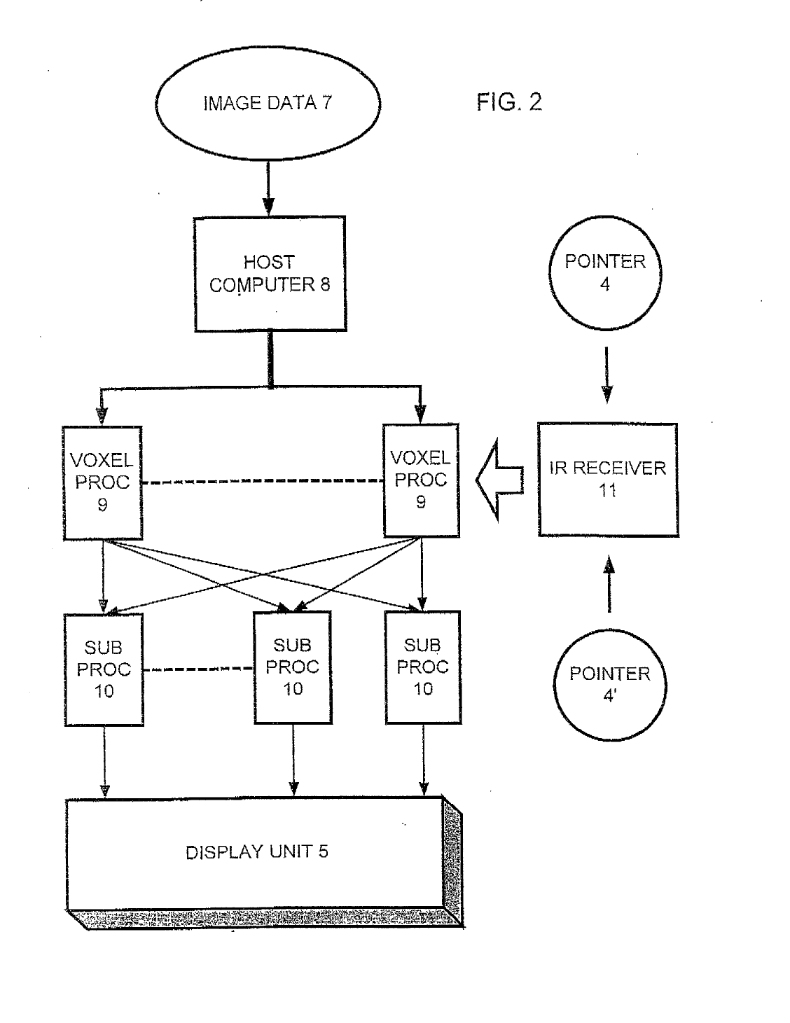

The pointer 4 is part of a volumetric display system shown schematically in FIG. 2. A display unit 5 creates visible voxels within the image space 1. A graphics engine includes a host computer 8 which receives image data from an image data source 7. The host computer feeds data in an appropriate form to an array of voxel processors 9, which each generate voxel descriptors and direct these voxel descriptors to an array of subspace processors 10. The subspace processors 10 are responsible for achieving rapid output of voxel descriptors to appropriate voxel activation mechanisms within the display unit 5.

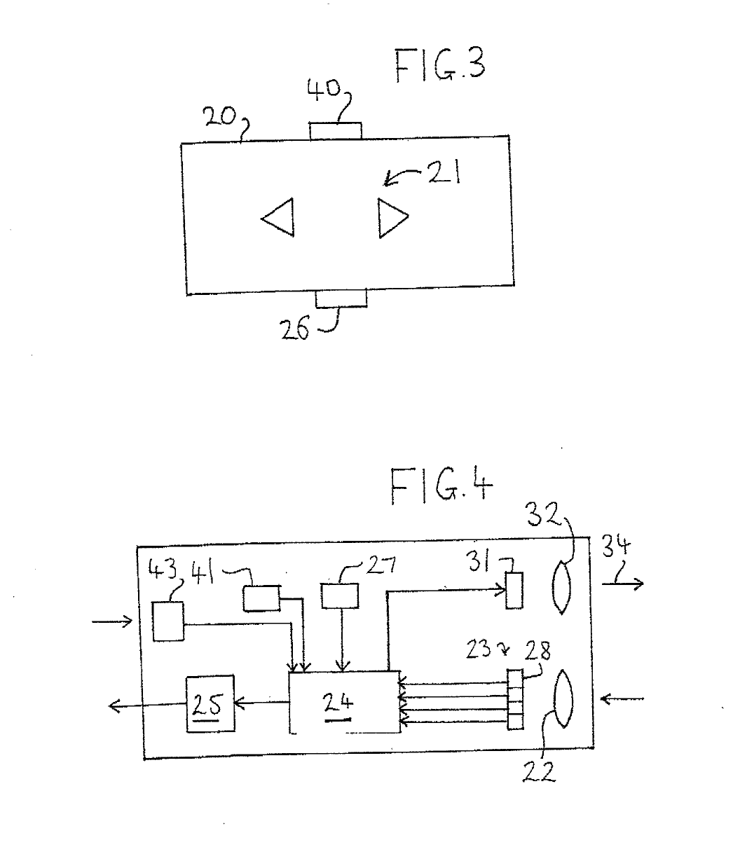

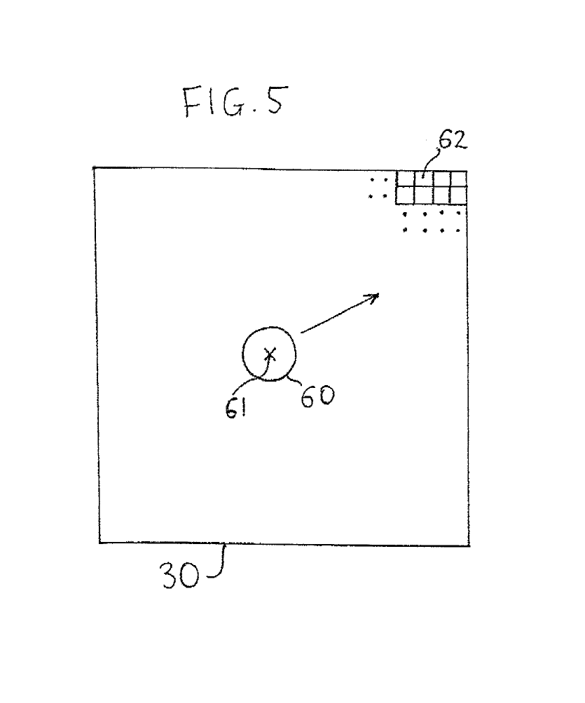

Referring to FIGS. 3 and 4, the pointer 4 has a casing 20 which carries movement buttons 21. The buttons 21 may be used to move the cursor 3 along a line of sight 50 or along a selected line (eg in the X direction indicated in FIG. 1). The pointer houses a lens 22 and a CCD array 23. The charge-coupled devices 28 in the array 23 detect radiation and output a two-dimensional set of image data to a processor 24 which transforms the data into an appropriate form for transmission to the graphics engine via an output interface 25. A suitable size of CCD array is likely to be of the order of 100×100, although the preferred size will depend on a variety of factors. The inventor recognises that in general a high resolution CCD is desirable, but the size of the CCD will ultimately be limited by the physical size of the pointer, cost restraints and processing power. The data link with the graphics engine may be in the form of a wired or wireless link. However in a preferred embodiment the output interface 25 includes a wireless (eg IR) transmitter and the graphics engine includes a receiver 11. This wireless link enables the pointer 4 to be moved around the image space 1 without tangling of wires. The two pointers 4,4′ communicate with the receiver on different channels. The output signals from the pointers are fed to the voxel processors 9 which perform some form of image operation on the basis of the received output signals.

The user can switch the movement buttons 21 between different modes (line-of-sight, X,Y,Z etc) using a selection button 26. Signals from the buttons 21,26 are input to the processor 24 via a button interface 27.

The graphics engine drives the display unit 5 in parallel. This means that at any one time there may be more than one voxel activated on the display unit 5, and a cursor recognition procedure must be followed.

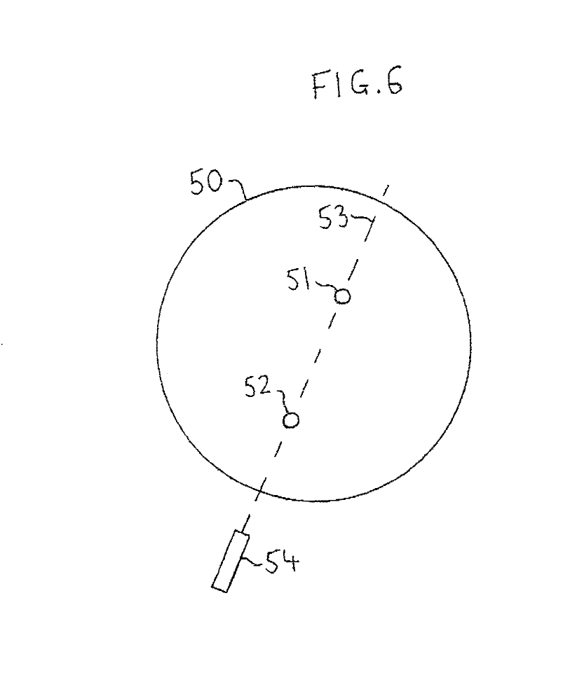

The intensity of the cursor 3 is time-encoded by the graphics engine. This may be achieved by activating the cursor once every other refresh period. Alternatively the signal addressing the voxels (eg a laser or electron beam) may be modulated during T_{d} (see equation (2) above) so as to vary the intensity of the cursor at a predetermined frequency higher than the refresh frequency. Whatever method is employed, this enables the voxel processors 9 to sense whether an image 60 of the cursor 3 is present in the two-dimensional image field 30 (see FIG. 5) acquired by the CCD array 23. If the cursor image 60 is detected then the graphics engine increases the intensity of the cursor 3, or changes its colour, to indicate that the cursor 3 has been ‘grabbed’ by the pointer. A second pointer 4′ (identical to pointer 4) may also be included as part of the system and if this pointer 4′ grabs the cursor 3 then the cursor 3 may be changed to a different colour, for example. Once the cursor 3 has been grabbed by a pointer, then as the pointer is moved, the position of the cursor image 60 changes as indicated by the arrow in FIG. 5. The graphics engine senses this movement and adjusts the position of the cursor so as to maintain the cursor image at some datum position (for instance the centre 61 of the image field 30). Provided that the image refresh frequency is sufficiently high (as it needs to be so as to achieve effective image animation) the pointer may be moved at an acceptable rate and the cursor's position updated so as to reflect the motion of the pointer.

Each CCD element 28 contributes to a single image pixel 62 in the image field 30 and it can be seen in FIG. 5 that the cursor image 60 is made up of a plurality of pixels 62.

The pointer 4 includes an ambient light sensor 43 which is directed away from the image field of the CCD array 23 and senses ambient light. The ambient light signal from the sensor 43 can be used by the processor 24 if necessary, and may be transmitted to the graphics engine as part of the output signal.

The pointer 4 includes a laser diode 31, collimating lens 32 and activation button 40. When the button 40 is depressed, a signal is sent to processor 24 via interface 41. The processor 24 activates the laser diode 31 and deactivates the CCD array 33. A pencil laser beam 34 is emitted which shows up as a spot on the support structure (eg glass) defining the image space 1 (in the case of a swept volume display unit) and may also show up as a spot or line within the image space 1. The laser spot or line enables the user to accurately sense the line of sight of the pointer and guide it towards the current position of the cursor 3. Once the laser spot or line is aligned with the cursor 3 then the button 33 is released, the laser diode 31 is turned off and the CCD array 23 is activated. Alternatively the laser diode 31 may be left on continuously.

A second cursor 33 (which is strobed at a different frequency to the cursor 3) may be displayed by the unit 5 and grabbed by the pointer 4′, enabling two users to interact simultaneously with the image 2, or enabling multiple control points for a single user.

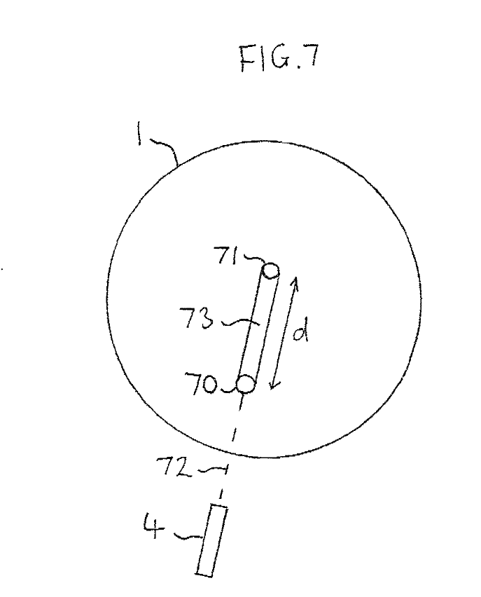

A method of constructing a line of voxels along a line of sight of the pointer is illustrated in FIG. 7. A spherical cursor 70 is grabbed by the pointer 4. The graphics engine then immediately displays a second cursor 71 at some default distance d away from the cursor 70, and moves the cursor 71 along a sphere, radius d until the second cursor is detected within the image field 30. The second cursor 71 is then moved until it disappears behind the image of the cursor 70 in the image field 30. At this point the cursor 71 will lie along the line of sight 72 in the position shown in FIG. 7. The graphics engine can then draw a line 73 between the two cursors 70,71. The length d of the line 73 can be controlled by a user by suitable manipulation of the buttons 21.

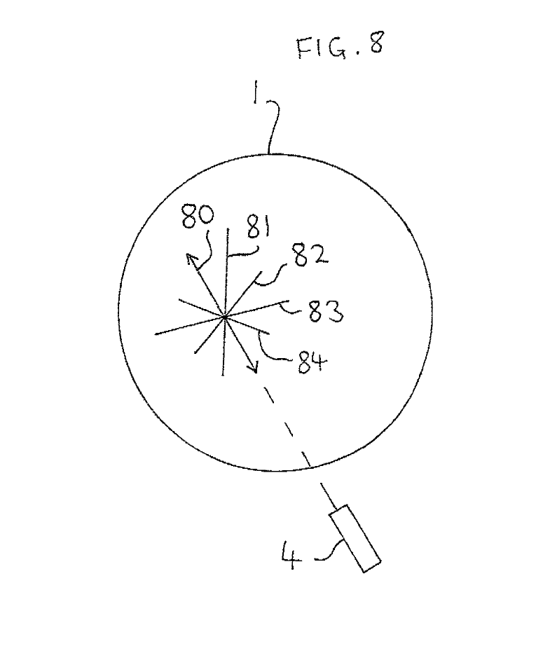

Once a line 73 has been constructed then this could be moved around the image volume by the user (in a sense it can be considered to be a ‘linear cursor’) and used as shown in FIG. 8. A linear cursor 80 has been moved to the position shown in FIG. 8 by the pointer 4 and intersects at a point with four other previously constructed lines 81-84. This enables the intersection point of the lines to be highlighted in a unique way.

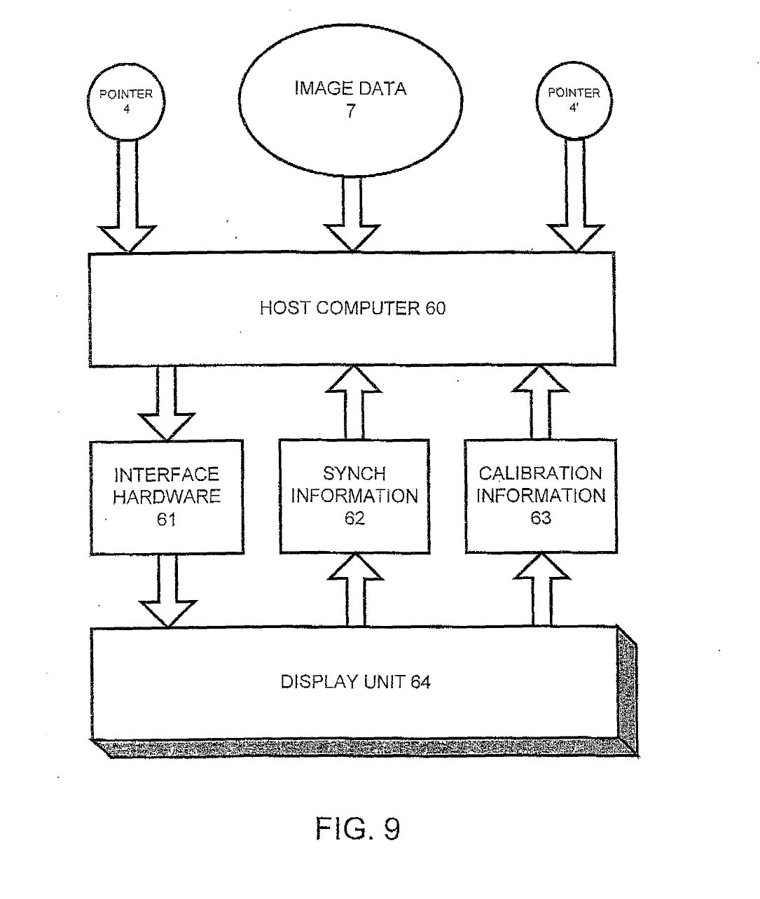

Although a specific graphics engine architecture is shown in FIG. 2, it will be understood that a variety of different architectures may be employed, as discussed in Blundell et al Chapter 9. For instance a serial architecture as shown in FIG. 9 may be employed. In this case the pointers 4,4′ input to a host computer 60 which communicates with a display unit 64 via serial interface hardware 61. Synchronisation information is communicated to the host computer via hardware 62 and display unit calibration information via hardware 63.

Where in the foregoing description reference has been made to integers or components having known equivalents then such equivalents are herein incorporated as if individually set forth.

Although this invention has been described by way of example it is to be appreciated that improvements and/or modifications may be made thereto without departing from the scope or spirit of the present invention.

What is claimed is:

1. A display system including a volumetric display unit for displaying voxels in a three-dimensional image space; a graphics engine for feeding image data to said volumetric display unit; and an interaction device having a radiation sensor for sensing radiation from a selected region of said three-dimensional image space and an output for feeding an output signal to said graphics engine, wherein said graphics engine is adapted to analyse said output signal in order to identify said selected region.

2. The system of claim 1 wherein said radiation sensor includes a two-dimensional array of radiation sensitive devices.

3. The system of claim 2 wherein said radiation sensitive devices are charge-coupled devices.

4. The system of claim 1 wherein said interaction device further includes a light transmitter for transmitting a visible beam of light which enables a user to determine a line of sight of said interaction device.

5. The system of claim 1 wherein said interaction device includes a radiation transmitter for transmitting said output signal to said graphics engine via a wireless link.

6. The system of claim 1 wherein said graphics engine is adapted to feed cursor image data to said display unit whereby said volumetric display unit displays a cursor image in said three-dimensional image space having a recognisable cursor attribute, and wherein said graphics engine is adapted to analyse said output signal to recognise the presence or absence of said recognisable cursor attribute in said output signal.

7. The system of claim 6 wherein said recognisable cursor attribute is a time varying code sequence.

8. The system of claim 7 wherein said time varying code sequence has a recognisable repetition frequency.

9. The system of claim 6 wherein said graphics engine is adapted to monitor a position of said cursor image within a two-dimensional image field of said radiation sensor, and move said cursor image in response to a change in said position of said cursor image within said two-dimensional image field of said radiation sensor.

10. The system of claim 1 further including one or more additional interaction devices, each having a radiation sensor for sensing radiation from said three-dimensional image space, and an output for feeding an output signal to said graphics engine.

11. The system of claim 1 further including an input device for inputting user instructions, wherein said graphics engine is adapted to identify a region of said three-dimensional image space in response to said user instructions as well as said output signal from said interaction device.

12. The system of claim 11 wherein said input device is part of said interaction device, and said user instructions are part of said output signal.

13. The system of claim 11 wherein said graphics engine is adapted to move a cursor image in response to said user instructions from said input device.

14. The system of claim 13 wherein said graphics engine is adapted to move said cursor image in a predetermined axis or plane in response to said user instructions.

15. The system of claim 1 wherein said graphics engine is adapted to feed said image data to said display unit in parallel whereby said display unit displays more than one of said voxels simultaneously.

16. A method of selecting a region of a three dimensional image space of a volumetric display system, the method including feeding image data to a volumetric display unit whereby said display unit displays voxels in said three-dimensional image space; sensing radiation from said selected region of said three-dimensional image space with a radiation sensor to generate an output signal; and analysing said output signal in order to identify said selected region.

17. The method of claim 16 including displaying a cursor image in said three-dimensional image space having a recognisable cursor attribute; and analysing said output signal to recognise the presence or absence of said recognisable cursor attribute in said output signal.

18. The method of claim 17 wherein said recognisable cursor attribute is a time varying code sequence.

19. The method of claim 18 wherein said time varying code sequence has a recognisable repetition frequency.

20. The method of claim 17 including monitoring a position of said cursor image within a two-dimensional image field; and moving said cursor image in response to a change in said position of said cursor image within said two-dimensional image field.

21. The method further including simultaneously sensing radiation from a second selected region of said three-dimensional image space to generate a second output signal; and analysing said second output signal in order to identify said second selected region.

22. The method of claim 16 including feeding said image data to said display unit in parallel whereby said display unit displays more than one of said voxels simultaneously.

23. The method of claim 16 including determining a line of sight of said radiation sensor by displaying a first marker at a first position along said line of sight in said three dimensional image space; displaying a second marker in said three dimensional image space; moving said second marker within said three dimensional image space; and analysing said output signal to sense when said second marker is at a second position along said line of sight.
